(19) United States
(12) Patent Application Publication
(10) Pub. No.: US 2012/0110722 A1
(43) Pub. Date: May 10, 2012

(54) Clip for Mounting a Fluid Delivery Device

(76) Inventors: Matthew Abbondanzio, Miwaukee, WI (US); Ronald J. Schmidt, Grayslake, IL (US); Jesse Richard, Racine, WI (US); Jason R. Gebhardt, Buffalo Grove, IL (US); Kristian Buschmann, Chicago, IL (US); Steve V. Bisbikis, Hawthorn Woods, IL (US); Paresh Shroff, Palatine, IL (US); Jonathan Daniel Toback, Chicago, IL (US); Christopher Kammerer, Chicago, IL (US); Saad Chaudry, Skokie, IL (US)

(21) Appl. No.: 13/291,477

(22) Filed: Nov. 8, 2011

Related U.S. Application Data
(60) Provisional application No. 61/411,825, filed on Nov. 9, 2010.
(60) Provisional application No. 61/417,384, filed on Nov. 26, 2010.
(60) Provisional application No. 61/513,466, filed on Jul. 29, 2011.

(51) Int. Cl. E03D 9/02; F16B 2/20; F16M 13/02

(52) U.S. Cl. 4/223; 248/231.81

(57) ABSTRACT

A clip for mounting a fluid delivery device adjacent a wall of an enclosure is disclosed. In one form, the clip mounts a fluid delivery device for spraying a fluid, such as a cleaner or deodorizer, on the inside surfaces of an enclosure, such as a toilet bowl, where the clip can be adjusted to fit different size toilet bowls. The clip includes a base configured to attach to the fluid delivery device, an adjustable mounting mechanism supporting the base adjacent the wall, and a biasing means for vertically biasing the base towards a top portion of the adjustable mounting mechanism. A device for spraying an inner surface of an enclosure with a fluid is also disclosed.

### CROSS-REFERENCES TO RELATED APPLICATIONS

This application claims priority from U.S. Patent Application No. 61/411,825 filed Nov. 9, 2010 and U.S. Patent Application No. 61/417,384 filed Nov. 26, 2010 and U.S. Patent Application No. 61/513,466 filed Jul. 29, 2011.

### STATEMENT REGARDING FEDERALLY SPONSORED RESEARCH

Not Applicable.

### BACKGROUND OF THE INVENTION

1. Field of the Invention

This invention relates to a clip for mounting a fluid delivery device for spraying a fluid, such as a cleaner or deodorizer, on the inside surfaces of an enclosure, such as a toilet bowl, where the clip can be adjusted to fit different size toilet bowls.

2. Description of the Related Art

Toilet bowls require care to prevent the buildup of unsightly deposits, to reduce odors, and to prevent bacteria growth. Traditionally, toilet bowls have been cleaned, deodorized, and disinfected by manual scrubbing with a liquid or powdered cleaning and sanitizing agent. This task has required manual labor to keep the toilet bowl clean.

In order to eliminate the detested manual scrubbing, various toilet bowl cleaner dispensers have been proposed. One type of dispenser comprises a solid block or solid particles of a cleansing and freshening substance that is suspended from the rim of a toilet bowl in a container that is placed in the path of the flushing water. U.S. Pat. No. 4,777,670 (which is incorporated herein by reference along with all other documents cited herein) shows an example of this type of toilet bowl cleaning system. Typically, a portion of the solid block is dissolved in the flush water with each flush, and the flush water having dissolved product is dispensed into the toilet bowl for cleaning the bowl.

Other toilet bowl cleaning systems use a liquid cleaning agent that is dispensed into a toilet bowl. For example, U.S. Pat. Nos. 6,178,564 and 6,230,334, and PCT International Publication Nos. WO 99/66139 and WO 99/66140 all disclose cleansing and/or freshening devices capable of being suspended from the rim of a toilet bowl for introducing liquid active substances from a bottle into the flushing water with each flush. In these under the toilet rim devices, the liquid active substances are delivered downward from a reservoir to a dispensing plate that is supported by a base that is suspended from the toilet bowl rim. The device is suspended from the toilet rim such that the flow of flush water from the toilet contacts the dispensing plate during a flush. The flush water carries the liquid active substances that are on the dispensing plate into the toilet bowl to clean and freshen the toilet.

Other toilet bowl dispensers use an aerosol deodorizing and/or cleaning agent that is dispensed into a toilet bowl through a conduit attached to the toilet bowl rim. For example, U.S. Pat. No. 3,178,070 discloses an aerosol container mounted by a bracket on a toilet rim with a tube extending over the rim; and U.S. Pat. Nos. 6,029,286 and 5,862,532 disclose dispensers for a toilet bowl including a pressurized reservoir of fluid, a conduit connected to the source of fluid, and a spray nozzle which is installed on the toilet rim.

One disadvantage with these known toilet rim dispensing devices is that these devices may only apply the deodorizing and/or cleaning agent to one location in the toilet water or a limited area in the toilet water or on the inner surface of the toilet bowl. As a result, the cleaning of the inner surface of the toilet bowl may be limited to an area of the toilet bowl near the device.

U.S. Pat. No. 7,603,726 sets forth, among others, an automatic or manual toilet bowl cleaning device where the inner surface of the toilet bowl is cleaned around the entire circumference of the toilet bowl. In one embodiment illustrated in that application, the downstream end of the conduit terminates in a nozzle capable of spraying the fluid outwardly onto the inner surface of the toilet bowl. The nozzle is attached near the rim of the toilet bowl.

Several techniques are available to provide adjustment for devices attached to the rim of a toilet bowl. Adjustment has been generally limited to either (1) accommodating toilet bowl rims of varying width, as shown in U.S. Pat. No. 6,029,286 wherein a ratchet arrangement between two members of the hook is used to adjust the hook for varying rim widths, or (2) attempting to accommodate the depth of the rim and bowl geometry by adjusting the vertical position of the device below the rim. For example, U.S. Pat. No. Re. 32,017 and U.S. Pat. Nos. 6,898,806 and 7,114,199 incorporate a ratchet arrangement between the hook and the body to allow discrete vertical adjustment of the device below the rim of a toilet bowl. Furthermore, U.S. Pat. No. 6,675,396 allows for continuous adjustment of the body with respect to the rim by the use of a friction fit wherein a flat bar hook is wedged within a hollow channel formed within the body. U.S. Patent Application Publication Nos. 2007/0240252 and 2008/0017762 also show various clips for mounting a nozzle near the rim of the toilet bowl.

However, there is still a need for an improved clip for mounting a nozzle near the rim of the toilet bowl having adjustment means that adequately position the nozzle so that the dispensed fluid reaches the extremes of the inner surface of the toilet bowl when the toilet bowl has an asymmetric or elongated rim/inner surface configuration.

### SUMMARY OF THE INVENTION

The foregoing needs can be met with a clip according to the present invention for mounting a fluid delivery device. The clip is suitable for use in an automated or manual cleaning system for cleaning an enclosure, such as a toilet bowl, a shower enclosure, a bathtub enclosure, and the like. As used herein, the term “cleaning” also includes sanitizing and/or disinfecting, the term “deodorizing” also includes freshening, and the term “fluid” includes cleaning fluids, sanitizing fluids, disinfecting fluids, and the like. Furthermore, the term “fluid” is read broadly to include, liquids, gels, flowable powders, vapors, and the like. Without limitation, an example embodiment of the invention will be described with reference to a toilet bowl.

The clip maintains the security and orientation of the fluid delivery device while in use to help ensure that the fluid is dispensed onto the desired enclosure surfaces. The clip is secured to the enclosure to prevent inadvertent or accidental movement that may cause undesired signals from the sensor and/or alter the coverage of the dispensed fluid. Additionally, the clip accommodates varying toilet sizes and shapes by adjusting for rim height, depth, angle, and curvature. Adjustment can be done substantially automatically as the clip is mounted to a rim. Grips on the hook help to ensure the orientation of the clip is maintained once set.

The present invention provides a clip for mounting a fluid delivery device adjacent a wall of an enclosure. The clip includes: a base; an arm connected to the base for attaching a fluid delivery device to the base; a hook configured to support the base adjacent the wall, the hook including a first section and a separate second section, the first section engaging the second section such that the first section can move toward and away from second section, the second section being attached to the base; and biasing means attached to the first section and the second section for biasing the first section toward the second section.

In one form of the of the clip, the first section engages the second section at an end section of the hook. Further, the second section is movably attached to the base such that the base can move toward and away from end section of the hook.

In another form of the clip, the base includes a tab that slidingly engages the second section.

In another form of the clip, clip further includes a second biasing means attached to the base and the second section for biasing the base toward the end section of the hook.

In another form of the clip, the first section has an outer segment and an end segment extending laterally from the first outer segment; the second section has an inner segment and an end casing connected to the inner segment; and the end segment moves in the top casing.

In another form of the clip, the biasing means is housed within the top casing.

In another form of the clip, the base includes a projection that extends toward the outer segment.

In another form of the clip, the enclosure is a toilet bowl; and the hook is dimensioned to hang on a rim of the toilet bowl and support the base adjacent an inner wall of the toilet bowl.

In another form of the clip, the outer segment contacts an outer surface of the toilet bowl, the end casing contacts a top surface of the rim, and the inner segment contacts an inner surface of the toilet bowl when the hook hangs on the rim.

In another form of the clip, the projection contacts an undersurface of the rim when the hook hangs on the rim.

In another form of the clip, the arm comprises a support segment and a barrel at the distal end of the support segment for supporting a fluid delivery device.

In another form of the clip, the base comprises a fluid inlet; and the clip includes a fluid delivery device comprising a nozzle in fluid communication with the fluid inlet.

In another form of the clip, the nozzle includes: a bottom wall; a passageway in fluid communication with the fluid inlet at an upper end of the passageway, the passageway extending between the fluid inlet and the bottom wall; a channel in fluid communication with a lower end of the passageway; and a pair of walls flanking the channel and extending upwardly from the bottom all, the walls being contacted by fluid to rotate the nozzle.

In another form of the clip, the nozzle is centrally located relative to a front face of the base.

The present invention further provides a device for spraying an inner surface of an enclosure with a fluid. The device includes: a container for the fluid; a fluid delivery device through which the fluid can be applied to the inner surface of the enclosure; a fluid conduit in fluid communication with the container and the fluid delivery device; means for delivering fluid from the container through the fluid conduit and to the fluid delivery device; and a clip. The clip includes: a base; an arm connected to the base for attaching the fluid delivery device to the base; a hook configured to support the base adjacent the wall, the hook including a first section and a separate second section, the first section engaging the second section such that the first section can move toward and away from second section, the second section being attached to the base; and biasing means attached to the first section and the second section for biasing the first section toward the second section.

In one form of the device, the means for delivering fluid from the container comprises a propellant.

In another form of the device, the enclosure is a toilet bowl, and the hook is dimensioned to hang on a rim of the toilet bowl and support the base adjacent an inner wall of the toilet bowl.

The present invention further provides a clip for mounting a fluid delivery device adjacent a wall of an enclosure. The clip includes a base; an arm connected to the base for attaching a fluid delivery device to the base; and a hook configured to support the base adjacent the wall. The hook includes a first section and a separate second section wherein the first section engages the second section such that the first section can move toward and away from second section. The second section is attached to the base. The first section engages the second section of the hook at an end section of the hook. The clip includes a first biasing means attached to the first section and the second section for biasing the first section toward the second section; and a second biasing means attached to the base and the second section for biasing the base toward the end section of the hook.

In one form of the device, the first biasing means horizontally biases the first section toward the second section.

In another form of the device, the second biasing means vertically biases the base toward the end section of the hook.

In another form of the device, the enclosure is a toilet bowl, and the end section of the hook is dimensioned to hang on a rim of the toilet bowl and support the base adjacent an inner wall of the toilet bowl.

In another aspect, the invention provides a clip for mounting a fluid delivery device adjacent a wall of an enclosure. The clip includes a support having a first side and an opposite second side, a base attached to the support wherein the base is structured for attaching the fluid delivery device to the base, a first arm having a first section extending laterally from the support and a second section extending downward from the first section, and a second arm having a first segment extending laterally from the support and a second segment extending downward from the first segment. The first arm and the second arm have an equilibrium position in which the first section and the first segment form a first angle facing away from the second side of the support. At least one of the first arm and the second arm can be elastically deflected to create a flexed position in which the first section and the first segment form a second angle facing away from the second side of the support. The second angle is less than the first angle.

In another form of the clip, the first arm and the second arm comprise part of a helical torsion spring, and the helical torsion spring is connected to the support, and the first arm and the second arm extend from opposite sides of the helical torsion spring.

In yet another form of the clip, the base is slidingly attached to the support.

In still another form of the clip, a biasing means is attached to the base and the support for biasing the base toward an end of the support.

In yet another form of the clip, the biasing means is a spring.

In still another form of the clip, the biasing means is housed within the support.

In yet another form of the clip, the base includes a projection that extends away from the second side of the support.

In still another form of the clip, the enclosure is a toilet bowl, and the first arm and the second arm are dimensioned to hang on a rim of the toilet bowl and support the base adjacent an inner wall of the toilet bowl.

In yet another form of the clip, the second section and the second segment contact an outer surface of the toilet bowl, and the first section and the first segment contact a top surface of the rim, and the support contacts an inner surface of the toilet bowl when the first arm and the second arm hang on the rim.

In still another form of the clip, the projection contacts an undersurface of the rim when the first arm and the second arm hang on the rim.

In yet another form of the clip, the base includes a barrel for supporting the fluid delivery device.

In still another form of the clip, the base comprises a fluid inlet, and the base supports a fluid delivery device comprising a nozzle in fluid communication with the fluid inlet.

In yet another form of the clip, the nozzle comprises a bottom wall, a passageway in fluid communication with the fluid inlet at an upper end of the passageway wherein the passageway extends between the fluid inlet and the bottom wall, a channel in fluid communication with a lower end of the passageway, and a pair of walls flanking the channel and extending upwardly from the bottom wall wherein the walls are contacted by fluid to rotate the nozzle.

In still another form of the clip, the base includes a shroud surrounding a portion of the nozzle.

In yet another form of the clip, the shroud has a transverse opening that provides a fluid path from the nozzle.

In yet another aspect, the invention provides a device for spraying an inner surface of an enclosure with a fluid. The device includes a container for the fluid; a fluid delivery device through which the fluid can be applied to the inner surface of the enclosure; a fluid conduit in fluid communication with the container and the fluid delivery device; means for delivering fluid from the container through the fluid conduit and to the fluid delivery device; and a clip for mounting the fluid delivery device adjacent a wall of the enclosure. The clip includes a support having a first side and an opposite second side, a base attached to the support wherein the base is structured for attaching the fluid delivery device to the base, a first arm having a first section extending laterally from the support and a second section extending downward from the first section, and a second arm having a first segment extending laterally from the support and a second segment extending downward from the first segment. The first arm and the second arm have an equilibrium position in which the first section and the first segment form a first angle facing away from the second side of the support. At least one of the first arm and the second arm can be elastically deflected to create a flexed position in which the first section and the first segment form a second angle facing away from the second side of the support. The second angle is less than the first angle.

In one form of the spraying device, the means for delivering fluid from the container comprises a propellant.

In another form of the spraying device, the enclosure is a toilet bowl, and the first arm and the second arm are dimensioned to hang on a rim of the toilet bowl and support the base adjacent an inner wall of the toilet bowl.

In yet another form of the spraying device, there is a sleeve for holding the fluid conduit adjacent the first arm.

In another aspect, the invention provides for a clip for mounting a fluid delivery device adjacent a wall of an enclosure. The clip includes a base configured to attach to the fluid delivery device and an adjustable mounting mechanism supporting the base adjacent the wall. The clip also includes a biasing means for vertically biasing the base towards a top portion of the adjustable mounting mechanism.

In one form of the clip, the biasing means is a spring, a first end of the spring is attached to the adjustable mounting mechanism and a second end of the spring is attached to the base.

In another form of the clip, the base includes a tab that slides within a channel of the adjustable mounting mechanism and the biasing means is housed within the adjustable mounting mechanism.

In still another form of the clip, the adjustable mounting mechanism includes a first arm, a second arm, and a vertical support with a first side an opposite second side, the vertical support engaging and supporting the base.

In yet another form of the clip, the second arm is configured to be flexed away from the first arm to mount the adjustable mounting mechanism to the enclosure.

In another aspect, the invention provides for a device for spraying an inner surface of an enclosure with a fluid. The device includes a container for the fluid, a fluid delivery device through which the fluid can be applied to the inner surface of the enclosure, and a fluid conduit in fluid communication with the container and the fluid delivery device. The device also includes means for delivering fluid from the container through the fluid conduit and to the fluid delivery device and a clip. The clip includes a base configured to attach to the fluid delivery device and an adjustable mounting mechanism supporting the base adjacent the wall. The clip also includes a biasing means for vertically biasing the base towards a top portion of the adjustable mounting mechanism.

In yet another aspect, the invention provides for a clip for mounting a fluid delivery device adjacent a wall of an enclosure. The clip includes a base configured to attach to the fluid delivery device and an adjustable mounting mechanism. The adjustable mounting mechanism includes a first arm, a second arm, and a vertical support. The vertical support supports the base adjacent the wall. The second arm is configured to be flexed away from the first arm to mount the adjustable mechanism to the enclosure. The base is vertically biased towards the first arm.

In one form of the clip, the base is vertically biased towards the first arm by a spring housed within a channel of the vertical support. The first end of the spring is attached to the first arm and a second end of the spring is attached to the base. The base is slidably attached to the vertical support.

It is therefore an advantage of the invention to provide a clip for mounting a fluid delivery device to a toilet bowl where the clip accommodates varying toilet sizes and shapes by adjusting for rim height, depth, angle, and curvature.

These and other features, aspects, and advantages of the present invention will become better understood upon consideration of the following detailed description, drawings, and appended claims.

### BRIEF DESCRIPTION OF THE DRAWINGS

FIG. 1A is a perspective view of a prior art toilet bowl cleaning assembly.

FIG. 1B is an enlarged, partially exploded view, of a prior art holder/activator used therewith.

FIG. 2 is top right perspective view of a clip for mounting a fluid delivery device in accordance with one embodiment of the invention.

FIG. 3 is a front view of the clip of FIG. 2.

FIG. 4 is a cross-sectional view of the clip taken along line 4-4 of FIG. 3.

FIG. 5 is a left side of the clip mounted on a box rim type toilet bowl.

FIG. 6 is an exploded view of the clip of FIG. 2.

FIG. 7 is a top, left perspective view of a clip for mounting a fluid delivery device in accordance with another embodiment of the invention.

FIG. 8 is a front elevational view of the clip of FIG. 7.

FIG. 9 is a right side elevational view of the clip of FIG. 7.

FIG. 10 is a cross-sectional view of the clip of FIG. 7 taken along line 10-10 of FIG. 8.

FIG. 11 is a top, left perspective view of a clip for mounting a fluid delivery device in accordance with yet another embodiment of the invention.

FIG. 12 is a front elevational view of the clip of FIG. 11.

FIG. 13 is a rear elevational view of the clip of FIG. 11.

FIG. 14 is a top plan view of the clip of FIG. 11.

FIG. 15 is a bottom plan view of the clip of FIG. 11.

FIG. 16 is a right side elevational view of the clip of FIG. 11.

FIG. 17 is a cross-sectional view of the clip of FIG. 11 taken along line 17-17 of FIG. 12.

Like reference numerals will be used to refer to like parts from Figure to Figure in the following description of the drawings.

### DETAILED DESCRIPTION OF THE INVENTION

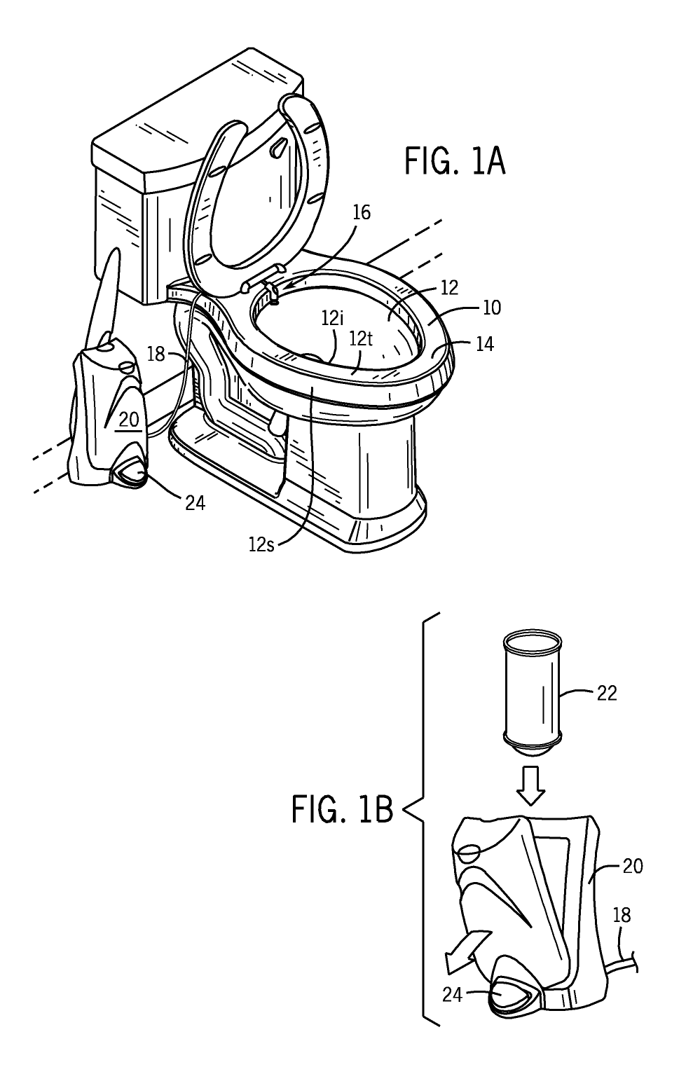

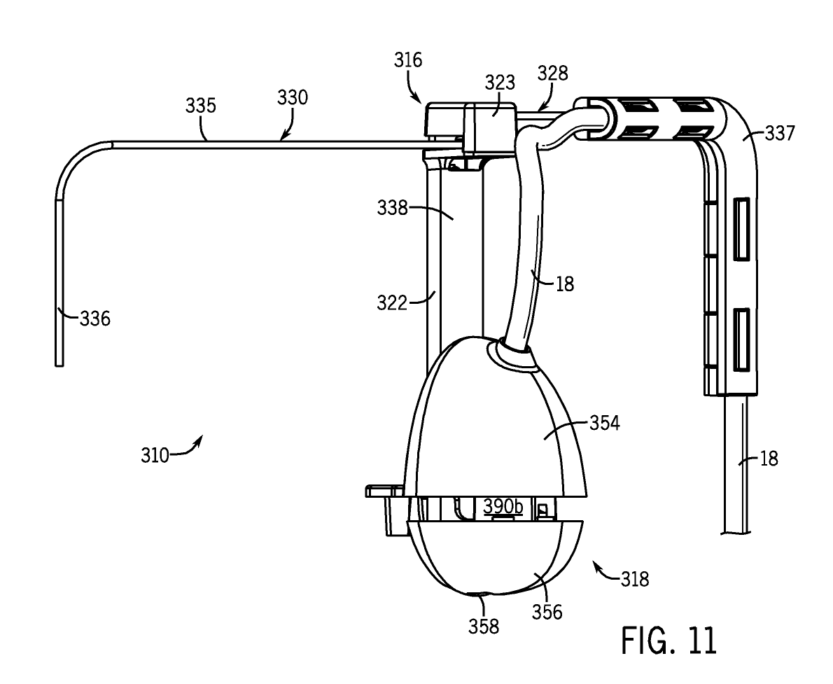

FIGS. 1A and 1B show a prior art toilet 10, per FIGS. 11A-D of U.S. Pat. No. 7,603,726. Toilet 10 has a bowl 12 with a top rim 14. A spray nozzle 16 is hooked over the rim and fed a cleaner by a conduit 18. The conduit 18 links to a holder 20 to which is mounted an aerosol container 22. Pressing down on a foot pedal 24 causes spraying of cleaner along the toilet bowl sides. This is a non-automated system that sprays for as long as the pedal is depressed.

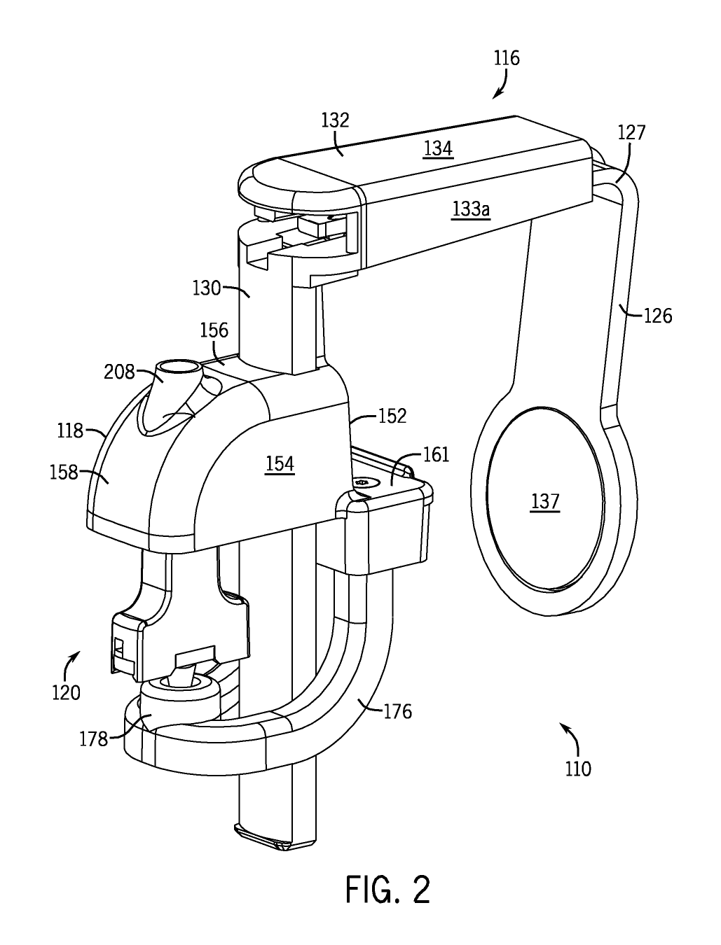

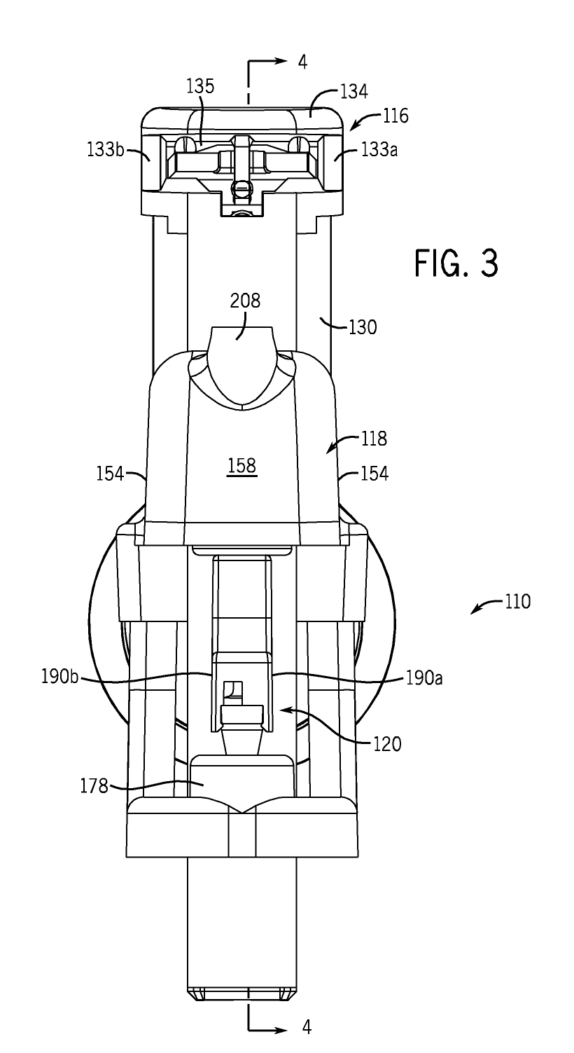

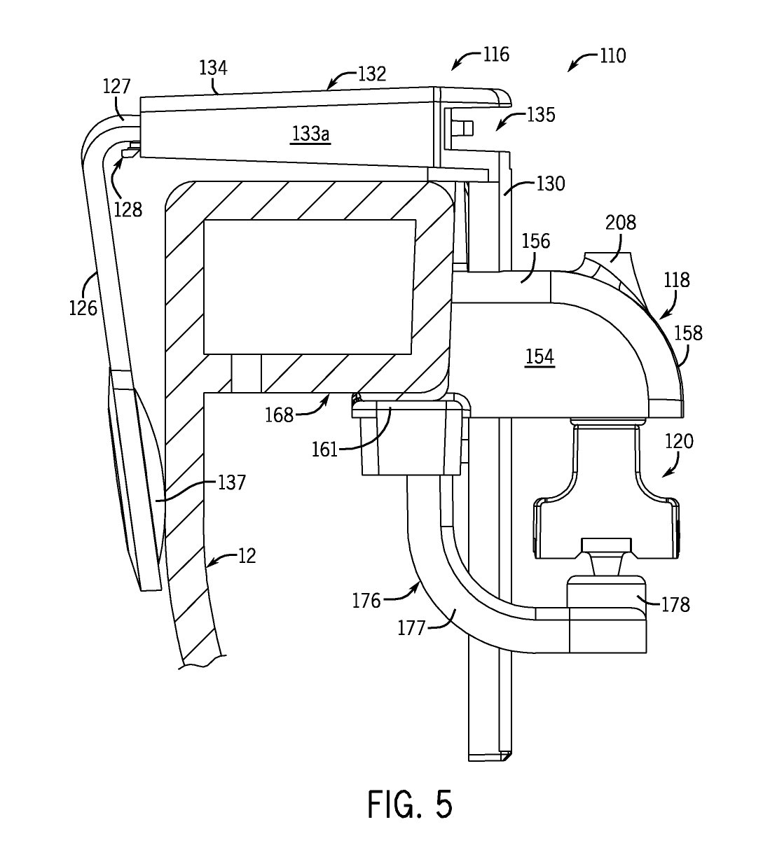

Turning now to FIGS. 2-6, there is shown an example embodiment of a clip 110 for mounting a fluid delivery device (e.g. a sprayer) to an enclosure such as a toilet bowl. The clip 110 is secured to the rim 14 of the toilet bowl 12 by an adjustable mounting mechanism, or hook 116, as shown in FIG. 5. A base 118 is supported by the hook 116 and supports a fluid delivery device, here a nozzle 120. A container supplies fluid via a fluid conduit to the fluid delivery device 120 to be dispensed onto the inside surface of the toilet bowl in the manner of the spray nozzle 16 of FIGS. 1A-1B. The fluid can be supplied from the container to the fluid delivery device 120 in a variety of ways; for example, the fluid may be motivated by a gaseous propellant, by a manual or electric pump, a syringe, or any other suitable means. Furthermore, the execution of the fluid delivery from the container can be controlled by a variety of methods/devices, one being a timing circuit using predetermined logic to control when the fluid is dispensed.

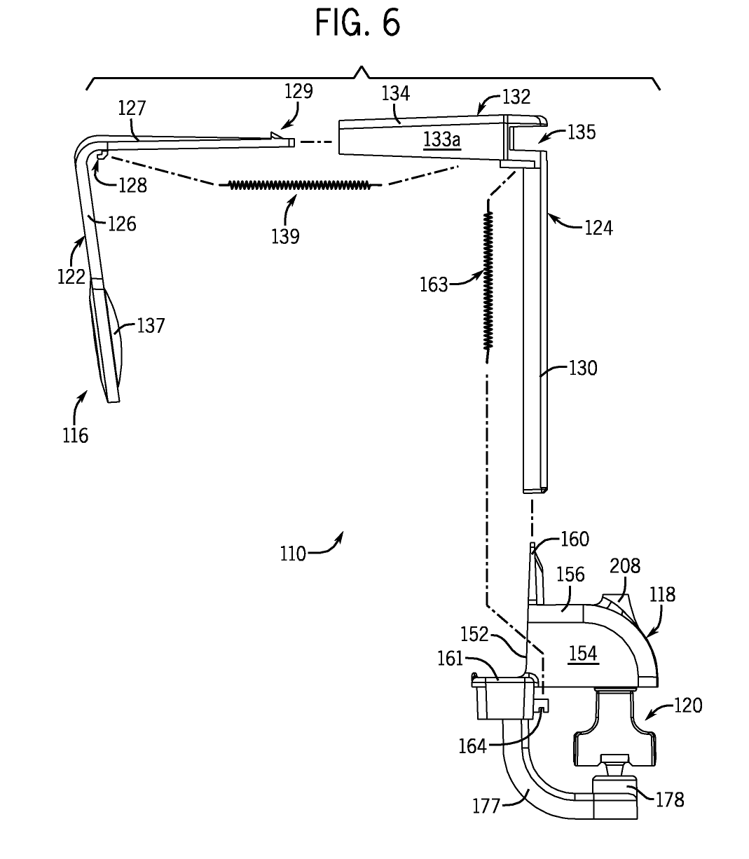

Looking at FIG. 6, the hook 116 for supporting the base 118 and attaching the clip 110 to the toilet bowl has a first section 122 and a second section 124. The first section 122 has an outer bowl segment 126 and a top rim segment 127 having a lower mounting hook 128 and an upper guide projection 129. The second section 124 has an inner rim segment 130 connected to a top rim casing 132 having spaced apart side walls 133a, 133b and a top wall 134 that define a channel 135 in the top rim casing 132. The first section 122 and the second section 124 are preferably molded from a polymeric material (e.g., polyethylene or polypropylene) and form the hook 116. The outer bowl segment 126 has an elastomeric gripping pad 137 at a lower end for helping to secure the clip 110 to the toilet bowl 12. Suitable elastomeric materials for the pad 137 include, without limitation, neoprene, polyurethane rubbers, and silicone rubbers. The inner rim segment 130 is configured to engage and support the base 118. The top rim casing 132 can include a C-shaped channel that restrains the fluid conduit 18 as it is routed around the perimeter of the hook 116 on its way to the nozzle 120 in the base 118.

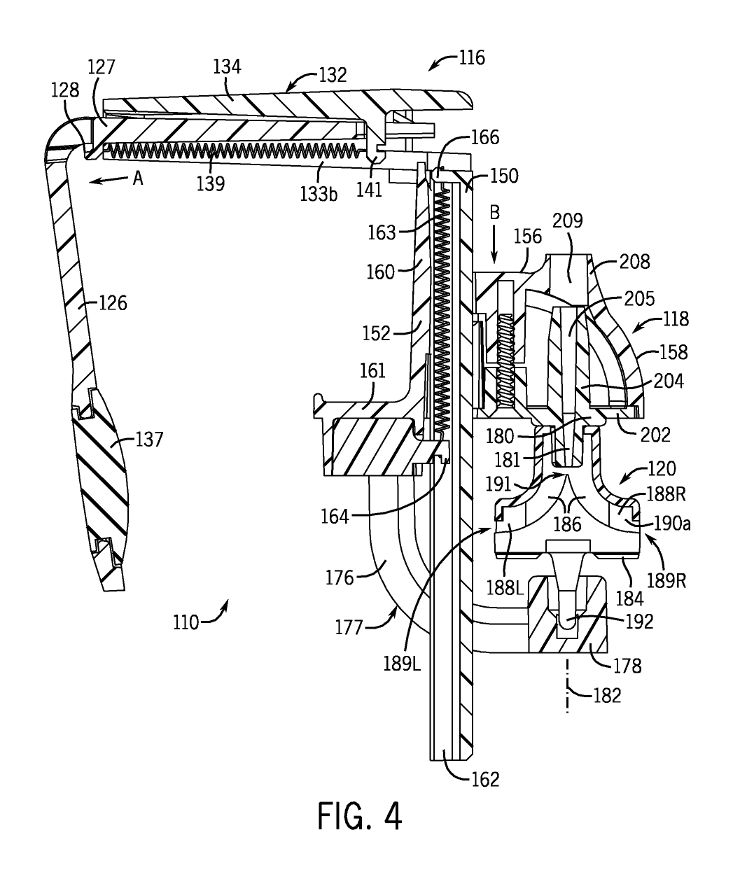

The top rim segment 127 slides in the channel 135 in the top rim casing 132 for mounting the clip 110 to the toilet bowl 12. The upper guide projection 129 travels in a channel in the undersurface of the top wall 134 of the top rim casing 132 to guide the top rim segment 127 during movement in the channel 135 of the top rim casing 132. An extension spring 139 is attached to the lower mounting hook 128 of the top rim segment 127 and a lower mounting hook 141 of the top wall 134 of the top rim casing 132. The spring 139 biases the outer bowl segment 126 and the top rim segment 127 of the first section 122 toward the inner rim segment 130 of the second section 124. Looking at FIG. 4, a user can apply a force in direction A on the outer bowl segment 126 to move the outer bowl segment 126 and the first section 122 away from the inner rim segment 130 of the second section 124. This creates a larger distance between the outer bowl segment 126 and the inner rim segment 130 when mounting the clip 110 to the toilet bowl 12. When the clip 110 has been mounted to the toilet bowl 12 as shown in FIG. 5, the spring 139 biases the outer bowl segment 126 toward the inner rim segment 130 of the second section 124 such that the outer bowl segment 126 and the inner rim segment 130 grip the opposed surfaces of the toilet bowl 12, and the top rim casing 132 rests on the top rim 14 of the toilet bowl 12.

The base 118 of the clip has a back face 152, a pair of spaced apart side faces 154 extending forward of the back face 152, a top face 156 and a front face 158 extending between the side faces 154. The faces 152, 154, 156, 158 define a cavity. The base 118 is preferably molded from plastic (e.g., polyethylene or polypropylene). The base 118 includes a tab 160 that extends upward from the back face 152 and a plate 161 that projects outward from the back face 152. The tab 160 is dimensioned to slide within a channel 162 of the outer bowl segment 126. An extension spring 163 is attached to an inwardly directed mounting hook 164 of back face 152 of the base 118 and also attached to a lower mounting hook 166 of the top rim casing 132.

A user can apply a force in direction B (see FIG. 4) on the base 118 to move the top rim casing 132 away from the base 118. This creates a larger distance between the top rim casing 132 and the base 118 when mounting the clip 110 to the toilet bowl 12. When the clip 110 has been mounted to the toilet bowl 12 as shown in FIG. 5, the spring 163 biases the top rim casing 132 toward the base 118 such that the top rim casing 132 grips the top rim 14 of the toilet bowl 12, and a top surface 167 of the plate 161 grips a undersurface 168 of the toilet bowl 12. In other words, the spring 163 vertically biases the base 118 towards a top portion of the hook 116.

The base 118 includes a means to attach a fluid delivery device (e.g., nozzle 120) to the base 118. In the example embodiment, the nozzle 120 is restrained laterally between a barrel 178 and a fluid inlet 180. The base 118 includes an arm 176 extending downward from the base 118. The arm 176 has a curved section 177 extending to the barrel 178 located at the distal end of the curved section 177. The fluid inlet 180 and the barrel 178 are used in conjunction to restrain lateral movement of the nozzle 120, but allow the nozzle 120 to rotate about the nozzle axis 182. The tubular fluid inlet 180 defines a flow path 181, and extends downwardly from a lower base floor 202 that is attached to the base 118. The base floor 202 includes an upwardly extending tubular sleeve 204 that defines a flow path 205. The base 118 is also attached to a fluid supply port 208 that defines a flow path 209. The fluid supply port 208 and the tubular sleeve 204 are snap fit together with an O-ring therebetween to create fluid tight seal. The fluid supply port 208 is located in the top face 156 of the base 118, and may be connected to a fluid conduit (such as conduit 18 in FIG. 1A).

Referring to FIG. 4, the inner flow paths of the nozzle 120 are shown in greater detail. The nozzle 120 is preferably molded from polymeric material (e.g., polyethylene and polypropylene). The nozzle 120 includes a bottom wall 184. An axial spindle 192 extends downward from the bottom wall 184. Spaced apart walls 190a, 190b, which have a generally inverted T-shape, extend upward from the bottom wall 184. A central fluid deflection peak 191 extends upward from the bottom wall 184 between the walls 190a, 190b. A passageway 186 is defined by the walls 190a, 190b and the passageway 186 extends upwards from the bottom wall 184. The contour of the walls 190a, 190b may vary depending on the desired rotational speed of the nozzle 120, the pressure of the fluid, the flow rate of the fluid, and the like.

As shown most clearly in FIG. 4, the nozzle 120 is restrained laterally by inserting a spindle 192 into a recess 179 in the barrel 178 of the arm 176 and by inserting the end of the fluid inlet 180 in depression 193. The nozzle 120 is free to rotate about the nozzle axis 182, but is restrained from lateral movement.

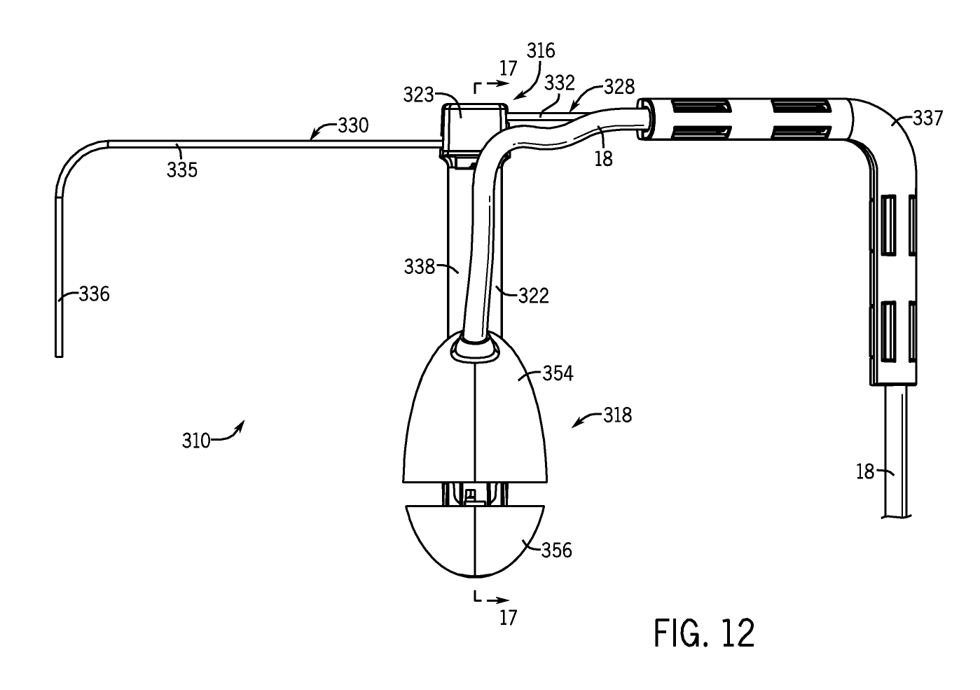

In operation, fluid is moved from a container through a fluid conduit (see, for example, the container 22 and the conduit 18 of FIG. 1) and into the fluid supply port 208. Looking at FIG. 12, the fluid flows through the flow paths 209, 205, and 181, and out of the fluid inlet 180. (The diameter of the exit orifice of the fluid inlet 180 can dictate the pressure which helps to dictate the spin rate and the distance of fluid travel off the nozzle 120.) Fluid flows onto the top of the fluid deflection peak 191 and down the forked passageways 186 where it is directed radially outward by channels 188L, 188R. As the fluid exits the channels 188L, 188R, the fluid path is altered by the angled inner surfaces flanking the channels 188L, 188R. The reaction causes the nozzle 120 to rotate. As a result, the fluid is expelled radially outward from fluid outlets 189L, 189R of the nozzle 120 onto the inside surface of the enclosure such as a toilet bowl.

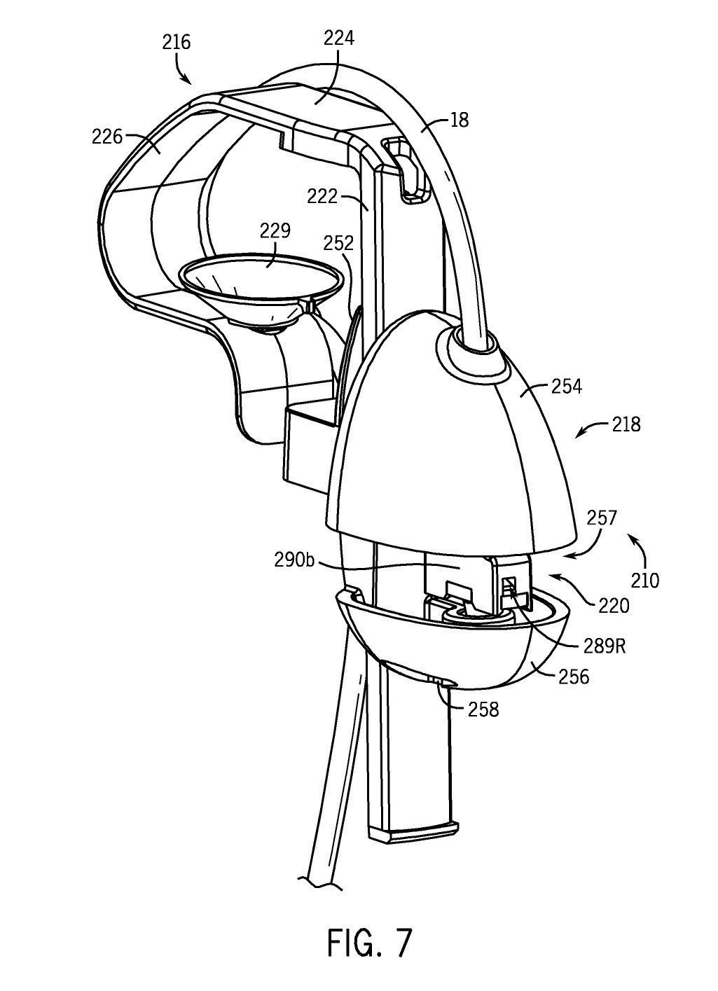

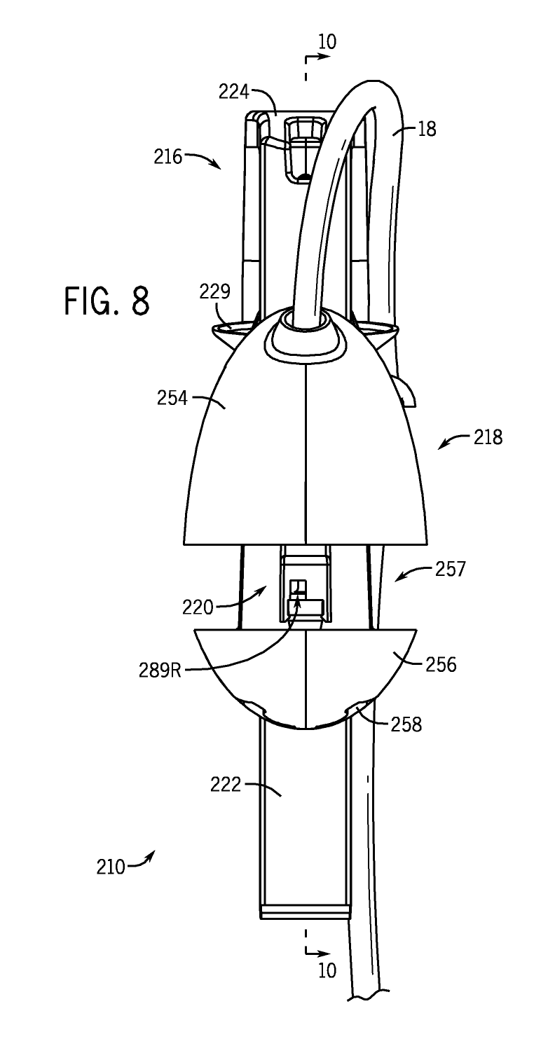

Turning now to FIGS. 7-10, there is shown an example embodiment of a clip 210 for mounting a fluid delivery device (e.g. a sprayer) to an enclosure such as a toilet bowl. The clip 210 is secured to the rim 14 of the toilet bowl 12 by an adjustable mounting mechanism 216, or hook. A base 218 is supported by the mounting mechanism 216 and supports a fluid delivery device, here a nozzle 220. A container supplies fluid via a fluid conduit 18 to the fluid delivery device 220 to be dispensed onto the inside surface of the toilet bowl in the manner of the spray nozzle 16 of FIGS. 1A-1B. The fluid can be supplied from the container to the fluid delivery device 220 in a variety of ways; for example, the fluid may be motivated by a gaseous propellant, by a manual or electric pump, a syringe, or any other suitable means. Furthermore, the execution of the fluid delivery from the container can be controlled by a variety of methods/devices, one being a timing circuit using predetermined logic to control when the fluid is dispensed.

The mounting mechanism 216 for supporting the base 218 and attaching the clip 210 to the toilet bowl 12 includes a vertical support 222 attached to a first arm 224 extending laterally from vertical support 222 and a flexing second arm 226 extending downward from the first arm 224. A clip 228 holds the fluid conduit 18 adjacent the second arm 226 as it is routed on its way to the nozzle 220 in the base 218. The support 222 is preferably molded from a polymeric material (e.g., polyethylene or polypropylene). A suction cup 229 is mounted on the inside of the second arm 226.

When the clip 210 is mounted to the toilet bowl 12, the second arm 226 is flexed outward such that the second arm 226 and the suction cup 229 contact an outer surface 12s of the toilet bowl 12, and the first arm 224 contacts a top surface 12t of the rim 14 of the toilet bowl 12, and a second side 239 of the support 222 contacts an inner surface 12i of the toilet bowl 12 as the first arm 224 and the second arm 226 hang on the rim 14. The suction force provided by the suction cup 229 on the outer surface 12s of the toilet bowl 12 keeps the second arm 226 in contact with the outer surface 12s of the toilet bowl 12.

The base 218 of the clip has a back face 252, a top front face 254, and a bottom front face 256 that form a hollow shroud around the nozzle 220. A transverse opening 257 is formed between the top front face 254 and the bottom front face 256. A drain opening 258 is provided in the bottom of the bottom front face 256 for draining away fluid that may accumulate inside the shroud. The base 218 is preferably molded from plastic (e.g., polyethylene or polypropylene).

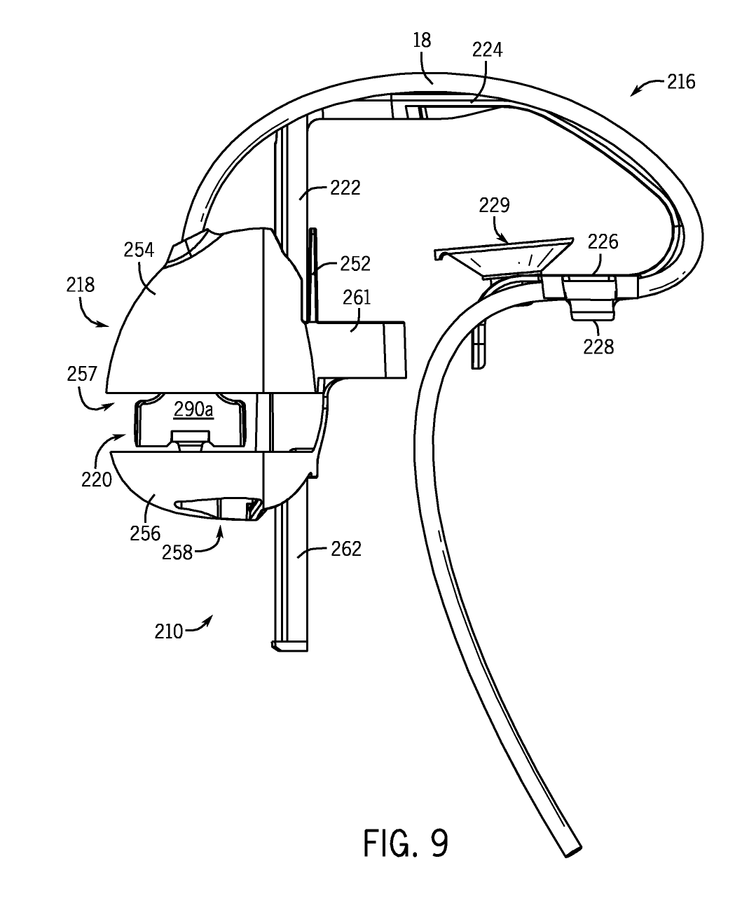

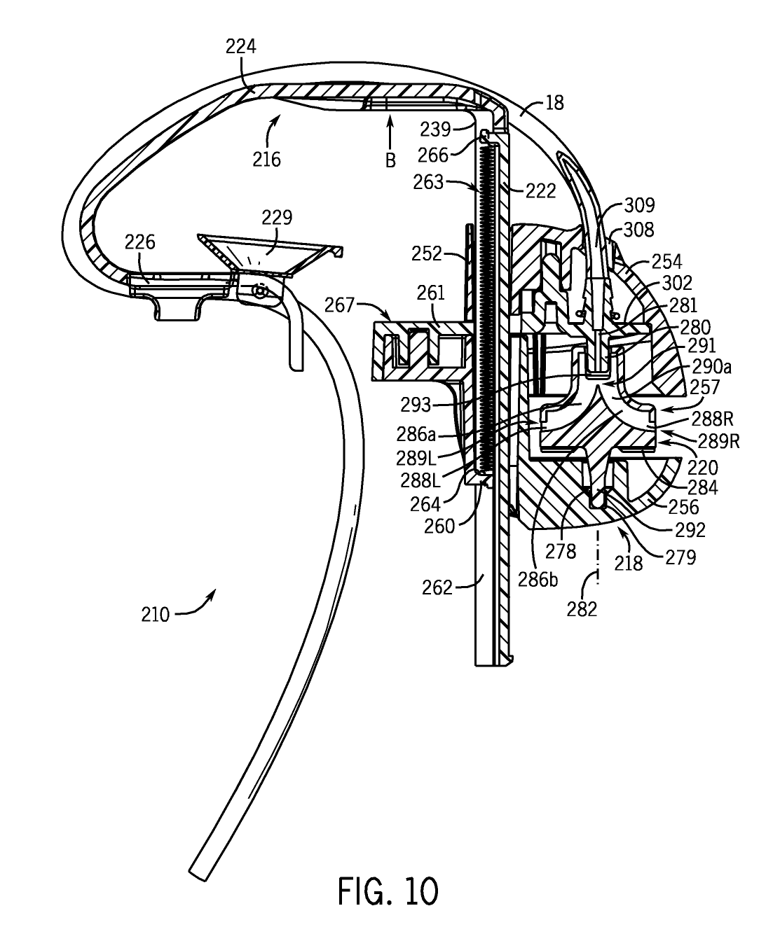

Looking at FIGS. 9 and 10, the base 218 includes a tab 260 that extends inward from the back face 252 and a plate 261 that projects outward from the back face 252. The tab 260 is dimensioned to slide within a channel 262 of the support 222. An extension spring 263 is attached to an inwardly directed mounting hook 264 of back face 252 of the base 218 and also attached to a mounting hook 266 of the support 222. The inwardly directed mounting hook 264 can form part of tab 260, illustrated in FIG. 10.

A user can apply a force in direction B (see FIG. 10) on the base 218 to move the first arm 224 away from the base 218. This creates a larger distance between the first arm 224 and the base 218 when mounting the clip 210 to the toilet bowl 12. When the clip 210 has been mounted to the toilet bowl 12, the spring 263 biases the first arm 224 toward the base 218 such that the first arm 224 grips the top rim 14 of the toilet bowl 12, and a top surface 267 of the plate 261 grips an undersurface of the toilet bowl 12. In other words, the spring 263 vertically biases the base 118 towards a top portion of the hook 116.

The base 218 includes a means to attach a fluid delivery device (e.g., nozzle 220) to the base 218. In the example embodiment, the nozzle 220 is restrained laterally between a barrel 278 and a fluid inlet 280. The fluid inlet 280 and the barrel 278 are used in conjunction to restrain lateral movement of the nozzle 220, but allow the nozzle 220 to rotate about the nozzle axis 282. The tubular fluid inlet 280 defines a flow path 281, and extends downwardly from a wall 302 that is attached to the base 218. The base 218 includes a fluid supply opening 251 that defines a flow path 309. The fluid supply opening 251 is located in the top front face 254 of the base 218, and may be connected to fluid conduit 18 (see FIG. 10).

The inner flow paths of the nozzle 220 are shown in greater detail. The nozzle 220 is preferably molded from polymeric material (e.g., polyethylene and polypropylene). The nozzle 220 includes a bottom wall 284. An axial spindle 292 extends downward from the bottom wall 284. Spaced apart walls 290a, 290b, which have a generally inverted T-shape, extend upward from the bottom wall 284. A central fluid deflection peak 291 extends upward from the bottom wall 284 between the walls 290a, 290b. Passageways 286a, 286b are defined by the walls 290a, 290b and the peak 291, and the passageways 286a, 286b extend upwards from the bottom wall 284. The contour of the walls 290a, 290b may vary depending on the desired rotational speed of the nozzle 220, the pressure of the fluid, the flow rate of the fluid, and the like.

The nozzle 220 is restrained laterally by inserting a spindle 292 into a recess 279 in the barrel 278 and by inserting the end of the fluid inlet 280 in depression 293. The nozzle 220 is free to rotate about the nozzle axis 282, but is restrained from lateral movement.

In operation, fluid is moved from a container through a fluid conduit (see, for example, the container 22 and the conduit 18 of FIG. 1A) and into the fluid supply opening 251. The fluid flows through the flow paths 309 and 281, and out of the fluid inlet 280. (The diameter of the exit orifice of the fluid inlet 280 can dictate the pressure which helps to dictate the spin rate and the distance of fluid travel off the nozzle 220.) Fluid flows onto the top of the fluid deflection peak 291 and down the forked passageways 286 where it is directed radially outward by channels 288L, 288R. As the fluid exits the channels 288L, 288R, the fluid path is altered by the angled inner surfaces flanking the channels 288L, 288R. The reaction causes the nozzle 220 to rotate. As a result, the fluid is expelled radially outward from fluid outlets 289L, 289R of the nozzle 220, through the transverse opening 257, and onto the inside surface of the enclosure such as the inner wall surface of a toilet bowl.

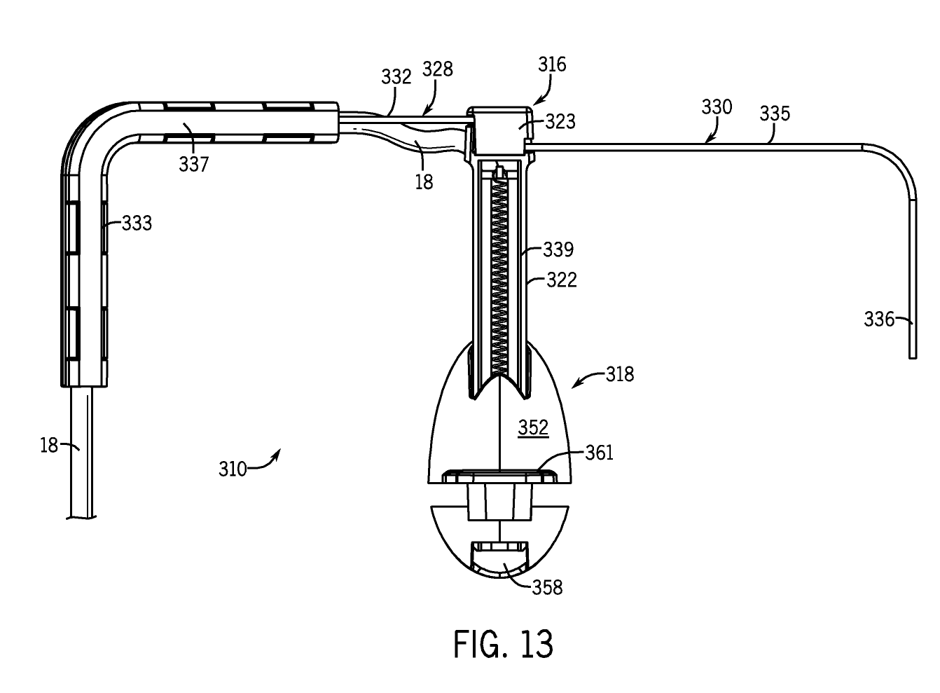

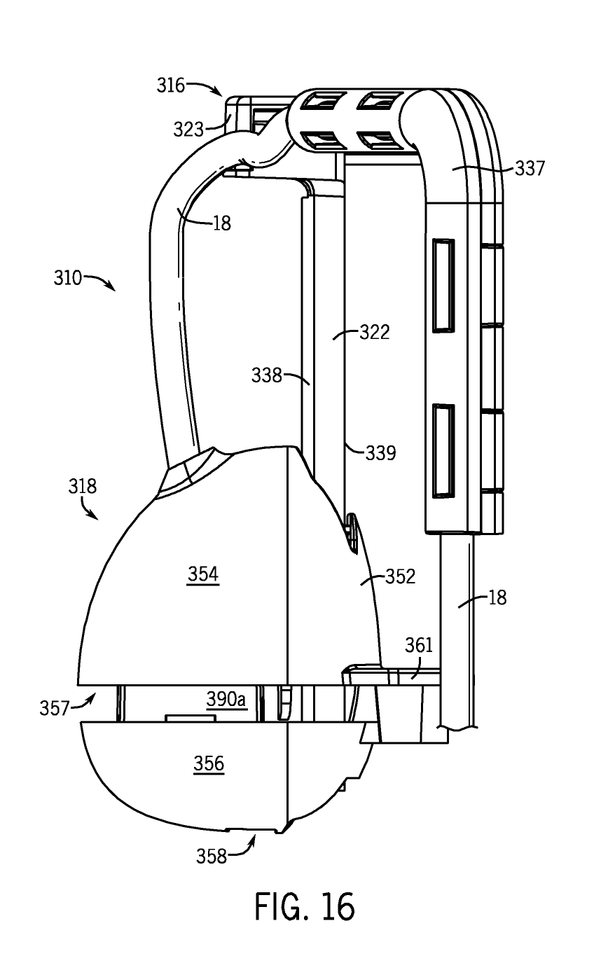

Turning now to FIGS. 11-17, there is shown an example embodiment of a clip 110 for mounting a fluid delivery device (e.g. a sprayer) to an enclosure such as a toilet bowl. The clip 310 is secured to the rim 14 of the toilet bowl 12 by an adjustable mounting mechanism 316, or hook. A base 318 is supported by the mounting mechanism 316 and supports a fluid delivery device, here a nozzle 320. A container supplies fluid via a fluid conduit 18 to the fluid delivery device 320 to be dispensed onto the inside surface of the toilet bowl in the manner of the spray nozzle 16 of FIGS. 1A-1B. The fluid can be supplied from the container to the fluid delivery device 320 in a variety of ways; for example, the fluid may be motivated by a gaseous propellant, by a manual or electric pump, a syringe, or any other suitable means. Furthermore, the execution of the fluid delivery from the container can be controlled by a variety of methods/devices, one being a timing circuit using predetermined logic to control when the fluid is dispensed.

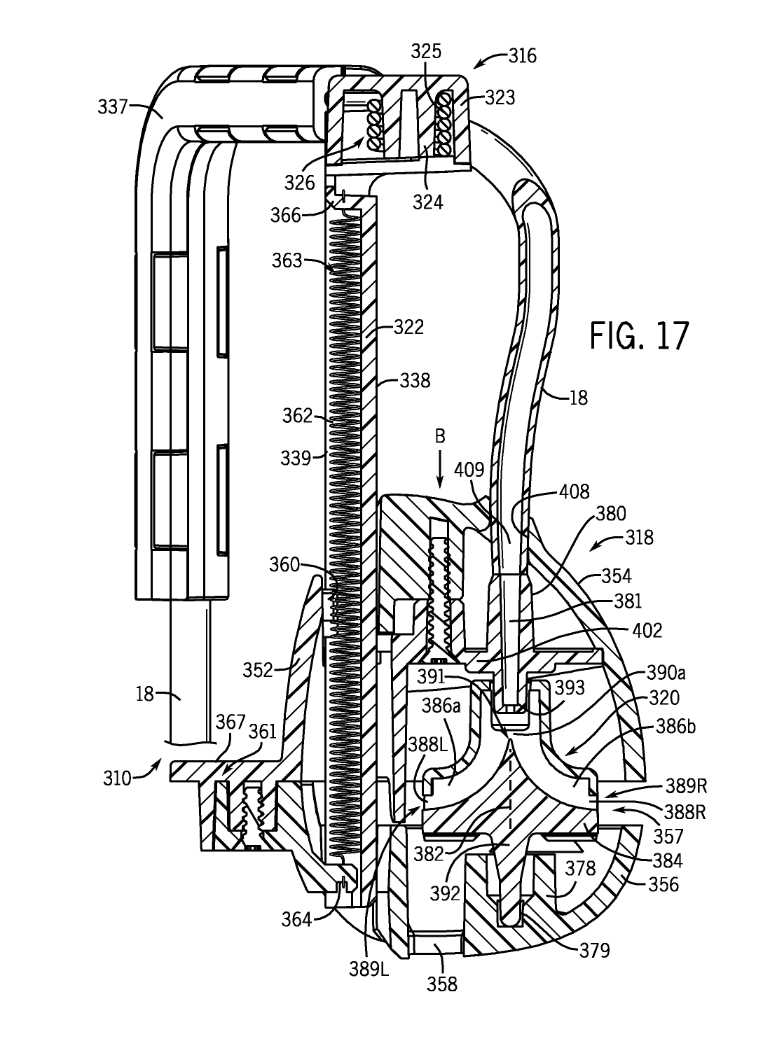

The mounting mechanism 316 for supporting the base 318 and attaching the clip 310 to the toilet bowl 12 includes a vertical support 322 with a top casing 323 having a pin 324 surrounded by a closed coil section 325 of a helical torsion spring 326 (see FIG. 17) which has a first arm 328 and a second arm 330. The first arm 328 has first section 332 extending laterally from the closed coil section 325 and a second section 333 extending downward from the first section 332. The second arm 330 has a first segment 335 extending laterally from the closed coil section 325 and a second segment 336 extending downward from the first segment 335. An elastic sleeve 337 holds the fluid conduit 18 adjacent the first arm 328 as it is routed on its way to the nozzle 320 in the base 318. The support 322 is preferably molded from a polymeric material (e.g., polyethylene or polypropylene). The helical torsion spring 326 can be formed from a suitable spring material such as stainless steel.

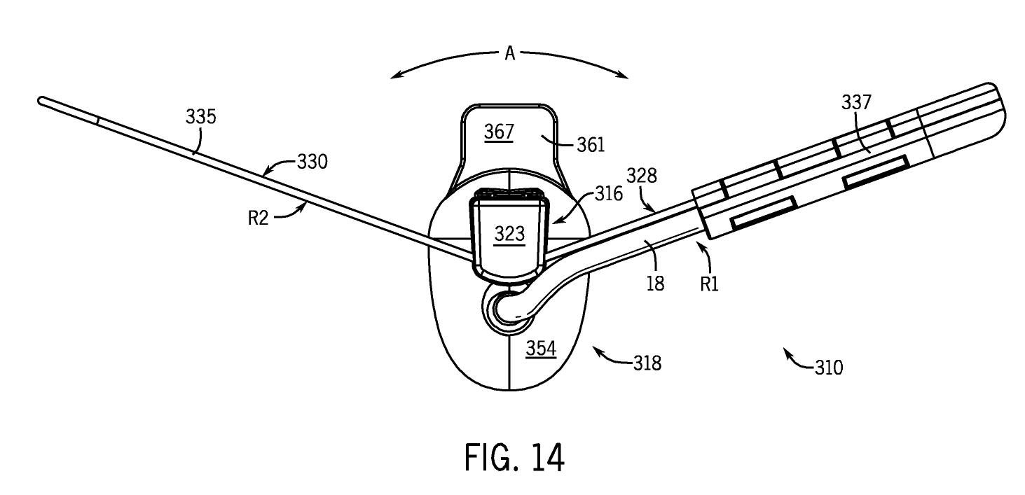

The support 322 has a first side 338 and an opposite second side 339. When the helical torsion spring 326 is in a relaxed undeflected position, the first arm 328 and the second arm 330 have an equilibrium position in which the first section 332 and the first segment 335 form a first angle A (see FIG. 14) facing away from the second side 339 of the support 322. A user can apply a force in direction R1 on the first arm 328 and/or apply a force in direction R2 on the second arm 330 to create a flexed position in which the first section 332 and the first segment 335 form a second angle facing away from the second side 339 of the support 322. As a result, the second angle is less than the first angle. This creates a larger distance between the second section 333 and the second side 339 of the support 322 and also creates a larger distance between the second segment 336 and the second side 339 of the support 322 when mounting the clip 310 to the toilet bowl 12.

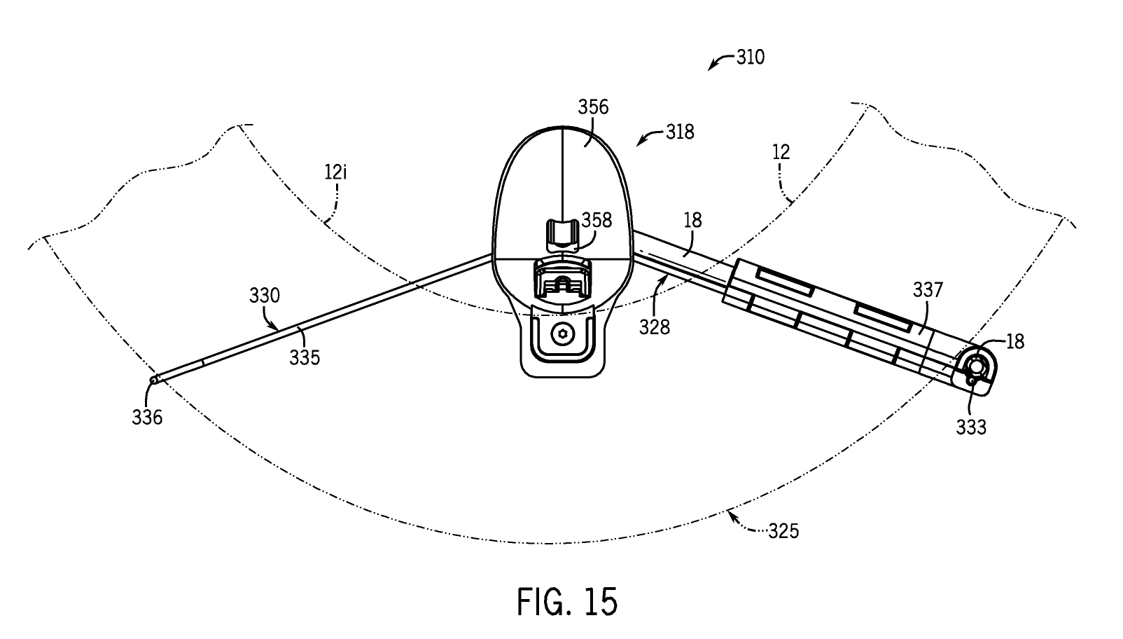

As shown in FIG. 15, when the clip 310 has been mounted to the toilet bowl 12 (shown as dashed lines in FIG. 15), the second section 333 and/or the sleeve 337 and the second segment 336 contact an outer surface 12s of the toilet bowl 12, and the first section 332 and the first segment 335 contact a top surface 12t of the rim 14 of the toilet bowl 12, and the second side 339 of the support 322 contacts an inner surface 12i of the toilet bowl 12 as the first arm 328 and the second arm 330 hang on the rim 14. The spring force provided by the helical torsion spring 326 on the first section 332 and the first segment 335 keeps the second section 333 and the second segment 336 in contact with the outer surface 12s of the toilet bowl 12 and the second side 339 of the support 322 in contact with the inner surface 12i of the toilet bowl 12 thereby trapping the mounting mechanism 316 to the toilet bowl 12.

The base 318 of the clip has a back face 352, a top front face 354, and a bottom front face 356 that form a hollow shroud around the nozzle 120. A transverse opening 357 is formed between the top front face 354 and the bottom front face 356. A drain opening 358 is provided in the bottom of the bottom front face 356 for draining away fluid that may accumulate inside the shroud. The base 318 is preferably molded from plastic (e.g., polyethylene or polypropylene).

Looking at FIG. 17, the base 318 includes a tab 360 that extends inward from the back face 352 and a plate 361 that projects outward from the back face 352. The tab 360 is dimensioned to slide within a channel 362 of the support 322. An extension spring 363 is attached to an inwardly directed mounting hook 364 of back face 352 of the base 318 and also attached to a mounting hook 366 of the support 322.

A user can apply a force in direction B (see FIG. 17) on the base 318 to move the top casing 323 away from the base 318. This creates a larger distance between the top casing 323 and the base 318 when mounting the clip 310 to the toilet bowl 12. When the clip 310 has been mounted to the toilet bowl 12, the spring 363 biases the top casing 323 toward the base 318 such that the first section 332 and the first segment 335 grip the top rim 14 of the toilet bowl 12, and a top surface 367 of the plate 361 grips an undersurface of the toilet bowl 12. In other words, the spring 363 vertically biases the base 318 towards a top portion of the adjustable mounting mechanism 316.

The base 318 includes a means to attach a fluid delivery device (e.g., nozzle 320) to the base 318. In the example embodiment, the nozzle 320 is restrained laterally between a barrel 378 and a fluid inlet 380. The fluid inlet 380 and the barrel 378 are used in conjunction to restrain lateral movement of the nozzle 320, but allow the nozzle 320 to rotate about the nozzle axis 382. The tubular fluid inlet 380 defines a flow path 381, and extends downwardly from a wall 402 that is attached to the base 318. The base 318 includes a fluid supply opening 408 that defines a flow path 409. The fluid supply opening 408 is located in the top front face 354 of the base 318, and may be connected to fluid conduit 18 (see FIG. 17).

Referring to FIG. 17, the inner flow paths of the nozzle 320 are shown in greater detail. The nozzle 320 is preferably molded from polymeric material (e.g., polyethylene and polypropylene). The nozzle 320 includes a bottom wall 384. An axial spindle 392 extends downward from the bottom wall 384. Spaced apart walls 390a, 390b, which have a generally inverted T-shape, extend upward from the bottom wall 384. A central fluid deflection peak 391 extends upward from the bottom wall 384 between the walls 390a, 390b. Passageways 386a, 386b are defined by the walls 390a, 390b and the peak 391, and the passageways 386a, 386b extend upwards from the bottom wall 384. The contour of the walls 390a, 390b may vary depending on the desired rotational speed of the nozzle 320, the pressure of the fluid, the flow rate of the fluid, and the like.

As shown in FIG. 17, the nozzle 320 is restrained laterally by inserting a spindle 392 into a recess 379 in the barrel 378 and by inserting the end of the fluid inlet 380 in depression 393. The nozzle 320 is free to rotate about the nozzle axis 382, but is restrained from lateral movement.

In operation, fluid is moved from a container through a fluid conduit (see, for example, the container 22 and the conduit 18 of FIG. 1A) and into the fluid supply opening 408. Looking at FIG. 17, the fluid flows through the flow paths 409 and 381, and out of the fluid inlet 380. (The diameter of the exit orifice of the fluid inlet 180 can dictate the pressure which helps to dictate the spin rate and the distance of fluid travel off the nozzle 320.) Fluid flows onto the top of the fluid deflection peak 391 and down the forked passageways 386 where it is directed radially outward by channels 388L, 388R. As the fluid exits the channels 388L, 388R, the fluid path is altered by the angled inner surfaces flanking the channels 388L, 388R. The reaction causes the nozzle 320 to rotate. As a result, the fluid is expelled radially outward from fluid outlets 389L, 389R of the nozzle 320, through the transverse opening 357, and onto the inside surface of the enclosure such as the inner wall surface of a toilet bowl.

Although the present invention has been described in detail with reference to certain embodiments, one skilled in the art will appreciate that the present invention can be practiced by other than the described embodiments, which have been presented for purposes of illustration and not of limitation. Therefore, the scope of the invention should not be limited to the description of the embodiments contained herein.

### INDUSTRIAL APPLICABILITY

The present invention provides a clip for mounting a fluid delivery device on a toilet bowl rim such that fluid is dispensed onto the inner surface of the toilet bowl.

All documents cited in the Detailed Description of the Invention are, in relevant part, incorporated herein by reference; the citation of any document is not to be construed as an admission that it is prior art with respect to the present invention.

What is claimed is:

1. A clip for mounting a fluid delivery device adjacent a wall of an enclosure, the clip comprising:
a base configured to attach to the fluid delivery device;
an adjustable mounting mechanism supporting the base adjacent the wall; and
a biasing means for vertically biasing the base towards a top portion of the adjustable mounting mechanism.

2. The clip of claim 1, wherein the biasing means is a spring, a first end of the spring is attached to the adjustable mounting mechanism and a second end of the spring is attached to the base.

3. The clip of claim 1, wherein the base includes a tab that slides within a channel of the adjustable mounting mechanism and the biasing means is housed within the adjustable mounting mechanism.

4. The clip of claim 1, wherein the adjustable mounting mechanism includes a first arm, a second arm, and a vertical support with a first side and an opposite second side, the vertical support engaging and supporting the base.

5. The clip of claim 4, wherein the second arm is configured to be flexed away from the first arm to mount the adjustable mounting mechanism to the enclosure.

6. The clip of claim 4, wherein the first arm has a first section extending laterally from the support and a second section extending downward from the first section, the second arm has a first segment extending laterally from the support and a second segment extending downward from the first segment, the first arm and the second arm having an equilibrium position in which the first section and the first segment form a first angle facing away from the second side of the support, and wherein at least one of the first arm and the second arm can be elastically deflected to create a flexed position in which the first section and the first segment form a second angle facing away from the second side of the support, the second angle being less than the first angle.

7. The clip of claim 6, wherein the first arm and the second arm comprise part of a helical torsion spring, the helical torsion spring is connected to the support, and the first arm and the second arm extend from opposite sides of the helical torsion spring.

8. The clip of claim 1, wherein the adjustable mounting mechanism includes a first section and a separate second section, the first section engaging the second section at an end section of the adjustable mounting mechanism such that the first section can move toward and away from the second section, the second section engaging and supporting the base, the clip further comprising:
a second biasing means attached to the first section and the second section for horizontally biasing the first section toward the second section.

9. The clip of claim 1, wherein the enclosure is a toilet bowl and the adjustable mounting mechanism is dimensioned to hang on a rim of the toilet bowl and support the base adjacent an inner wall of the toilet bowl.

10. A device for spraying an inner surface of an enclosure with a fluid, the device comprising:
a container for the fluid;
a fluid delivery device through which the fluid can be applied to the inner surface of the enclosure;
a fluid conduit in fluid communication with the container and the fluid delivery device;
means for delivering fluid from the container through the fluid conduit and to the fluid delivery device; and
a clip comprising:
a base configured to attach to the fluid delivery device;
an adjustable mounting mechanism supporting the base adjacent the wall; and
a biasing means for biasing the base towards a top portion of the adjustable mounting mechanism.

11. The device of claim 10, wherein the biasing means is a spring, a first end of the spring is attached to the adjustable mounting mechanism, and a second end of the spring is attached to the base.

12. The device of claim 10, wherein the base includes a tab that slides within a channel of the adjustable mounting mechanism and the biasing means is housed within the adjustable mounting mechanism.

13. The device of claim 10, wherein the adjustable mounting mechanism includes a first arm, a second arm, and a vertical support with a first side and an opposite second side, the vertical support engaging and supporting the base.

14. The device of claim 13, wherein the second arm is configured to be flexed away from the first arm to mount the adjustable mounting mechanism to the enclosure.

15. The device of claim 13, wherein the first arm has a first section extending laterally from the support and a second section extending downward from the first section, the second arm has a first segment extending laterally from the support and a second segment extending downward from the first segment, the first arm and the second arm having an equilibrium position in which the first section and the first segment form a first angle facing away from the second side of the support, and wherein at least one of the first arm and the second arm can be elastically deflected to create a flexed position in which the first section and the first segment form a second angle facing away from the second side of the support, the second angle being less than the first angle.

16. The device of claim 10, wherein the base includes a back face, a top front face, and a bottom front face that form a hollow shroud around the fluid delivery device

17. The device of claim 10, wherein the adjustable mounting mechanism includes a first section and a separate second section, the first section engaging the second section at an end section of the adjustable mounting mechanism such that the first section can move toward and way from the second section, the second section engaging and supporting the base, the clip further comprising:
a second biasing means attached to the first section and the second section for horizontally biasing the first section toward the second section.

18. The device of claim 10, wherein the enclosure is a toilet bowl and the adjustable mounting mechanism is dimensioned to hang on a rim of the toilet bowl and support the base adjacent an inner wall of the toilet bowl.

19. A clip for mounting a fluid delivery device adjacent a wall of an enclosure, the clip comprising:
a base configured to attach to the fluid delivery device; and
an adjustable mounting mechanism including a first arm, a second arm, and a vertical support, the vertical support supporting the base adjacent the wall, the second arm being configured to be flexed away from the first arm to mount the adjustable mechanism to the enclosure;
the base being vertically biased towards the first arm.

20. The clip of claim 19, wherein the base is vertically biased towards the first arm by a spring housed within a channel of the vertical support, a first end of the spring being attached to the first arm and a second end of the spring being attached to the base, the base being slidably attached to the vertical support.
